(19) United States
(12) Patent Application Publication
(10) Pub. No.: US 2023/0070384 A1
(43) Pub. Date: Mar. 9, 2023

(54) Thermal Radiation Vehicle Night Vision System

(71) Applicant: NightRide Thermal LLC, Brooklyn, NY (US)

(72) Inventors: Shawn Groce, Broklyn, NY (US); Zevi Kramer, Brooklyn, NY (US); Jacky Yuan, New York, NY (US)

(21) Appl. No.: 17/959,163

(22) Filed: Oct. 3, 2022

Related U.S. Application Data
(63) Continuation-in-part of application No. 16/902,448, filed on Jun. 16, 2020, now Pat. No. 11,463,661.
(60) Provisional application No. 62/862,734, filed on Jun. 18, 2019.

(51) Int. Cl. B60R 1/22; G01J 5/02; B60R 11/00; H04N 5/225; H04N 7/18; H04N 5/77

(52) U.S. Cl. CPC B60R 1/22; G01J 5/0205; G01J 5/028; B60R 11/00; H04N 5/2253; H04N 7/183; H04N 5/77; G01J 2005/0077

(57) ABSTRACT

A night vision system including a thermal radiation night vision device for removably mounting to an exterior of a vehicle. The night vision device is to detect thermal radiation for objects present around the vehicle and to create a video with the detected objects. The created video may be communicated to a display device located within an interior region of the vehicle for displaying the video stream to a user driving the vehicle. The system may include a connector having a standard interface to easily and securely connect to a mounting device that is designed to mount to a roof, a light bar, a fender, a grill or a bumper of the vehicle. The mounting device may be configured to replace a portion of a frame of a spotlight mounted to the vehicle in order to secure the thermal radiation night vision device to the spotlight.

### PRIORITY

This application is a continuation in part (CIP) of and claims benefit under 35 USC § 120 of U.S. patent application Ser. No. 16/902,448 filed on Jun. 16, 2020 (issued as U.S. Pat. No. 11,453,661 on Oct. 4, 2022). U.S. patent application Ser. No. 16/902,448 claims priority under 35 USC § 119 of U.S. provisional patent application 62/862,734 filed on Jun. 18, 2019. Application Ser. No. 16/902,448 and 62/862,734 are incorporated herein by reference in their entirety.

### BACKGROUND

According to the National Safety Council of the United States, the risk of a fatal crash is three times greater at night when it is dark. Depth perception, color recognition and peripheral vision can be compromised in the dark. The nighttime vision issues may increase as we get older. Furthermore, the risk of accidents may increase at night because the driver may be more tired. Moreover, the glare of headlights from an oncoming vehicle can temporarily blind a driver. All of these issues may play a role in the increased fatality rates associated with driving at night.

Night vision systems may be used by drivers at night to see objects in relatively low light conditions. The use of a night vision system may be a possible solution for lowering the risks involved with night driving. Night vision systems may be active or passive systems. Active systems include a light source to shine light (non-visible light) in front of the vehicle and a camera to receive light reflected off any objects and a display to display those objects. The light source may provide infrared or near infrared light. A passive system does not require the light source. Rather, the camera is designed to detect thermal radiation that is emitted from objects and to display the thermal radiation detected.

Active and passive night vision systems have been incorporated into some high-end vehicles. The vehicles may not be affordable or desirable for all consumers. Furthermore, a system integrated with the vehicle cannot be used with other vehicles or in other situations.

Thus, what is needed is a night vision system that can be utilized on many different types of vehicles. The system may include a thermal camera that may be securely mounted to various locations on a vehicle. The thermal camera may be removed from a vehicle and used on other vehicles. The system may be capable of providing thermal images captured to a plurality of different display devices so that a user can use the type of display they desire.

### BRIEF DESCRIPTION OF THE DRAWINGS

For a more complete understanding of the invention, there will now be described some embodiments thereof, given by way of example, reference being made to the accompanying drawings, in which:

FIG. 1 illustrates a block diagram of an example thermal radiation night vision system for use on a vehicle, according to one embodiment;

FIG. 2 illustrates a functional diagram of an example night vision device that may be utilized in the example thermal radiation night vision system, according to one embodiment;

FIG. 3 illustrates a functional diagram of an example display device that may be utilized with the example thermal radiation night vision system, according to one embodiment;

FIGS. 4A-C illustrate an example configuration for securing a night vision device to a hood of a vehicle, according to one embodiment;

FIGS. 5A-C illustrate various views of an example night vision device that includes a connection means that enables it to be secured to various mounting devices for securing to various parts of a vehicle, according to one embodiment;

FIGS. 6A-6C illustrate the use of mounting devices to secure night vision devices to various different locations on the vehicle, according to different embodiments;

FIG. 7A illustrates an example night vision device capable of wireless charging, according to one embodiment;

FIG. 7B illustrates the wireless charging night vision device of FIG. 7A being mounted to a windshield of a vehicle, according to one embodiment; and

FIG. 8 illustrates a display device utilized with a thermal radiation night vision system mounted within a vehicle, according to one embodiment.

### DETAILED DESCRIPTION

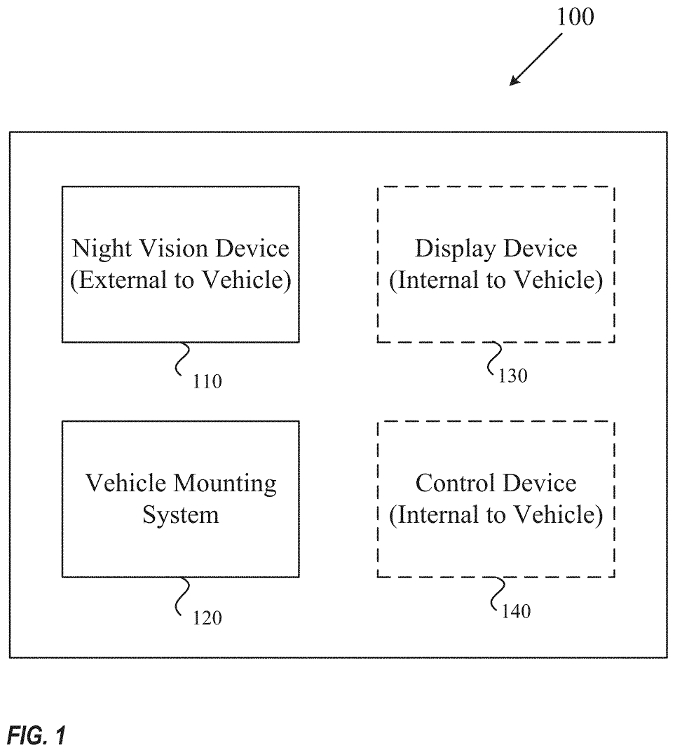

FIG. 1 illustrates a block diagram of an example thermal radiation night vision system 100 for use on a vehicle. The system 100 includes a night vision device 110, a mounting device 120 and a display device 130. The night vision device 110 may be an infrared radiation (IR) detector that detects thermal radiation emanating from objects. In order to detect thermal radiation, the night vision device 110 needs to located external to the vehicle so that the vehicle (e.g., windshield, frame) does not block receipt of the thermal radiation.

The mounting device 120 may be any number of components that enable the night vision device 110 to be mounted external to the vehicle. The mounting device 120 must be able to secure the night vision device 110 to the vehicle while the vehicle is moving. According to one embodiment, the mounting device 120 may enable the night vision device 110 to be removed from the vehicle in a fairly quick and easy fashion to allow the night vision device 110 to be, for example, stored in a secure location (e.g., within vehicle, at work, at home) or used with a different vehicle. According to one embodiment, the mounting device 120 may secure the night vision device 110 to the vehicle in a semi-permanent fashion (e.g., require tools to remove) so that the night vision device 110 typically remains mounted to the vehicle. The mounting device 120 may be part of a housing of the night vision device 110 (such that housing is secured to vehicle) or may located between, and connect to, the housing of the night vision device 110 and the vehicle.

The display device 130 may be any device that is capable of receiving information from the night vision device 110 and displaying the information for viewing by a driver (and/or passenger) of the vehicle. The display device 130 may be capable of communicating with the night vision device 110. The communications may be wireless or wired communications. The communications between the display device 130 and the night vision device 110 is not separately illustrated. The display device may be, for example, a laptop computer, a tablet computer or a smart phone (e.g., iPhone®, Android®). The display device 130 utilized may be changed either within the vehicle or different vehicles may have different display devices 130. A user could utilize any display device 130 they wanted that had the ability to communicate with the night vision device 110 and display the thermal images thereon.

While the display device 130 is needed to display the objects associated with thermal radiation detected within the vehicle in real time, the night vision device 110 would still capture the videos if a display device 130 was not included. The videos could then be viewed at a later time when the display device 130 was available either in the vehicle or separate from the vehicle. Accordingly, the display device 130 is not required to be included as part of the system 100 (as such it is illustrated as a dotted line).

The display device 130 may be capable of adjusting what is displayed thereon (e.g., increase/decrease zoom, change color selection). The display device 130 may also be used as a user interface for the night vision device 110 to set various parameters therefore (e.g., password, record preferences, update software preferences, power preferences). According to one embodiment, the display device 130 may be used to control movement (e.g., tilt, rotate) of the night vision device 110, if the night vision device 110 is capable of such movements.

According to one embodiment, the system 100 may optionally include a control device 140. The control device 140 would be located within the vehicle and enable a user of the system 100 to control the night vision device 110. According to one embodiment, the control device 140 could cause the night vision device 110 to rotate up or down or to possibly rotate around (e.g., 360 degrees) to enable the night vision device 110 to capture thermal radiation from objects around the vehicle. The control device 140 could communicate with the night vision device 110 via a wired or wireless link. The control device 140 could be powered by the vehicle. The control device 140 could be connected to the vehicles power by, for example, connecting to an internal power source (e.g., fuse box, lighter, USB port). According to one embodiment, the control device 140 could provide power to the night vision device 110 via a wired link (e.g., power over ethernet).

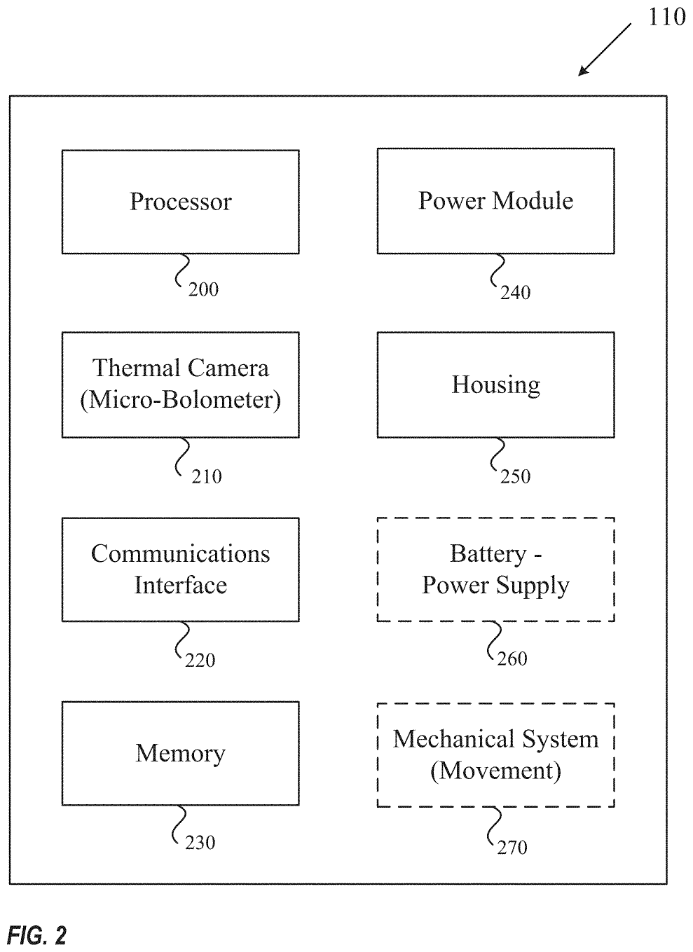

FIG. 2 illustrates a functional diagram of an example night vision device 110. The night vision device 110 includes a processor 200, an IR detector 210, a communications interface 220, a memory 230, a power module 240 and a housing 250. The processor 200 is to control the operation of the device 110. The processor 200 may read and execute instructions that determine the actions that the processor 200 takes to control the operation of the device 110. The processor 200 may include memory for storing the instructions (or at least a portion of the instructions) and/or the instructions (or at least a portion of the instructions) may be stored remote from the processor 200.

The IR detector 210 is to detect thermal radiation from objects located within a certain distance therefrom. The IR detector 210 may include a camera (lens) to capture radiation (including thermal radiation) from objects located in front thereof. The IR detector 210 may include, for example, a microbolometer to convert the thermal radiation captured into image(s) depicting the objects. The processor 200 may receive information (e.g., captured radiation, images of objects associated therewith) from the IR detector 210 and processes the same to generate a video stream corresponding to the objects emitting thermal radiation located with a certain distance in front of the IR detector 210.

The communications interface 220 is to provide communications with the display device 130. The communications interface 220 may be capable of supporting wired and/or wireless communications. The communications interface 220 may include one or more wireless modules (e.g., WiFi) to enable wireless communications with the display device 130. The communications interface 220 may include one or more ports (e.g., Ethernet, USB) for receiving an associated cable to support wired communications with the display device 130. The communications between the night vision device 110 and the display device 130 may include, for example, providing the video stream from the night vision device 110 to the display device 130 (for display and/or storage) and using the display device 130 as a user interface for interacting with the night vision device 110.

According to an embodiment in which a control device 140 is utilized, the communication interface 220 is also capable of providing wired and/or wireless communications therewith. The communications interface 220 may include one or more wireless modules (e.g., Bluetooth, infrared) to support wireless communication with the control device 140. The communications interface 220 may include one or more ports (e.g., Ethernet, USB) for receiving an associated one or more cables to support wired communications with the control device 140. The control device 140 may be utilized by a user to control different aspects of the operation of the night vision device 110.

The memory 230 may be used to store the videos streams generated by the night vision system 110. The memory 230 may also be used to store configuration information, preferences, and/or the like that are used to operate the night vision device 110. The memory 230 may also be used to store the instructions (or at least a portion of the instructions) that are read and executed by the processor 200. The power module 240 is to receive a supply voltage from an external source and to convert it to a voltage necessary to operate the various components of the night vision device 110. The external source providing the voltage thereto may be, for example, a vehicle battery or a battery pack. The power module 240 may include a port for receiving a cable from the external source. The type of cable and port may vary depending on the external source. For example, a USB cable to be used to provide power from a battery pack. A cable used for connecting to a vehicle battery may include, for example, alligator clips to connect to the terminals of the battery.

According to one embodiment, the voltage from the external power source may be wirelessly transmitted to the night vision device 110. The external power source may include, for example, an inductive transmitter and the power module 240 may include an inductive receiver that are utilized to wirelessly transmit the power.

The housing 250 is used to hold the various components therewithin and to secure the IR detector 210 in a position to receive the thermal radiation form objects. The housing 250 should be made of a material capable of withstanding the elements (e.g., rain, snow, high/low temperatures, sunlight). Furthermore, the housing 250 should be made of a material capable of being secured to a vehicle where the vehicle may travel at high speeds or on rough terrain. The housing 250 may be capable of being secured to the vehicle in some fashion.

The housing 250 may be configured to secure to a vehicle mounting system 120. According to one embodiment, the housing 250 may include a connection means that may be utilized to connect to various different mounting devices 120 that may be used to connect to various parts of the vehicle. The connection means may have a standard configuration that the various mounting devices 120 would be designed to secured to. The connection means could be designed to receive a portion of the mounts or to be received by the mounts. The connection means and the mounts could further be secured together with, for example, screws and bolts. According to one embodiment, the housing 250 may include a magnet therein that is capable of securing the night vision device 110 to the steel of the vehicle (e.g., hood, roof).

The night vision device 110 may optionally include a battery or power supply 260 that is utilized to provide power thereto so that a connection to an external power source is not required. The battery/power supply 260 may be capable of providing the necessary operating voltage directly or may provide a voltage to the power module 240 to convert it to appropriate operating voltage(s) for the night vision device 110.

The night vision device 110 may optionally include a mechanical system 270 that is utilized to move the night vision device 110. The mechanical system 270 may include various components capable of moving portions of the night vision device 110. For example, the mechanical system 270 may be capable of adjusting the IR detector 210 up, down, left and/or right to adjust the objects that will be captured. The mechanical system 270 may be capable of rotating the housing 250 so that the location of the IR detector 210 with respect to the direction of the vehicle is adjusted. According to one embodiment, it may be possible to rotate at least a portion of the housing 250 360 degrees so that the IR detector 210 can capture thermal radiation in any direction around the vehicle. The mechanical system 270 may be capable of locating the IR detector 210 internal to a portion of the housing 250 for protection when the night vision device 110 is not being used. The mechanical system 270 may be controlled by a user within the vehicle. The control may be provided by the display device 130 and/or the control device 140.

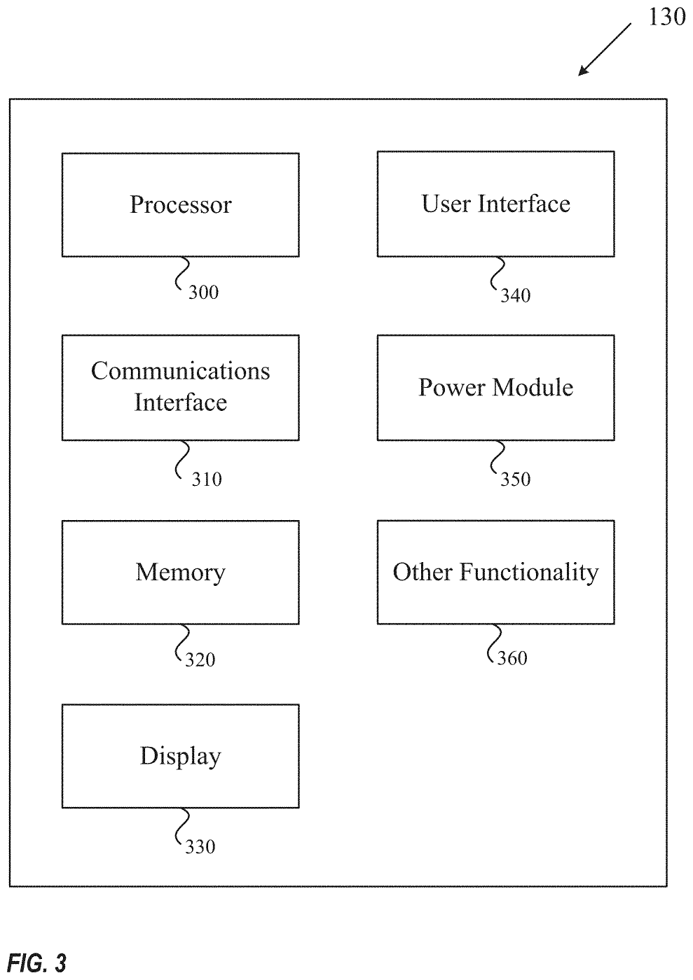

FIG. 3 illustrates a functional diagram of an example display device 130. As previously noted, the display device 130 may be a smart phone, a tablet, a laptop, display device integrated with the vehicle, or any other device that may communicate with the night vision device 110 and display the thermal images to a user (e.g., driver, passenger). The display device 130 may include a processor 300, a communications interface 310, a memory 320, a display 330, a user interface 340, a power module 350, and other functionality 360. The processor 300 may read and execute instructions that determine the actions that the processor 300 takes to control the operation of the device 130. The processor 300 may include memory for storing the instructions (or at least a portion of the instructions) and/or the instructions (or at least a portion of the instructions) may be stored remote from the processor 300.

The communications interface 310 is to provide communications with other devices and periphery including the night vision device 130. The communications interface 310 may be capable of supporting wired and/or wireless communications. The communications interface 310 may include one or more wireless modules (e.g., WiFi, Bluetooth) to enable wireless communications and one or more ports (e.g., Ethernet, USB) for receiving an associated cable to support wired communications. The communications between the night vision device 110 and the display device 130 may include, for example, receiving the video stream from the night vision device 110 or providing instructions for adjusting the night vision device 110.

The memory 320 may be used to store information for various reasons. The memory 320 may also be used to store the instructions (or at least a portion of the instructions) that are read and executed by the processor 300. The display 330 is used to present information to a user including when used as part of the night vision system 100 displaying the thermal radiation videos. The user interface 340 is to enable the user to interact with the display device 300. The user interface 340 may be any combination of devices, including but not limited to, a keyboard, a mouse, and a touch screen. The power module 350 is to provide voltages necessary to operate the display device 130. The power module 350 may include ports for receiving external power and/or an internal battery.

The other functions 360 may be functions associated with the display device 130 that are not necessarily related to the night vision system 100. For example, if the display device 130 was a smart phone the other functions could be functions related to making calls.

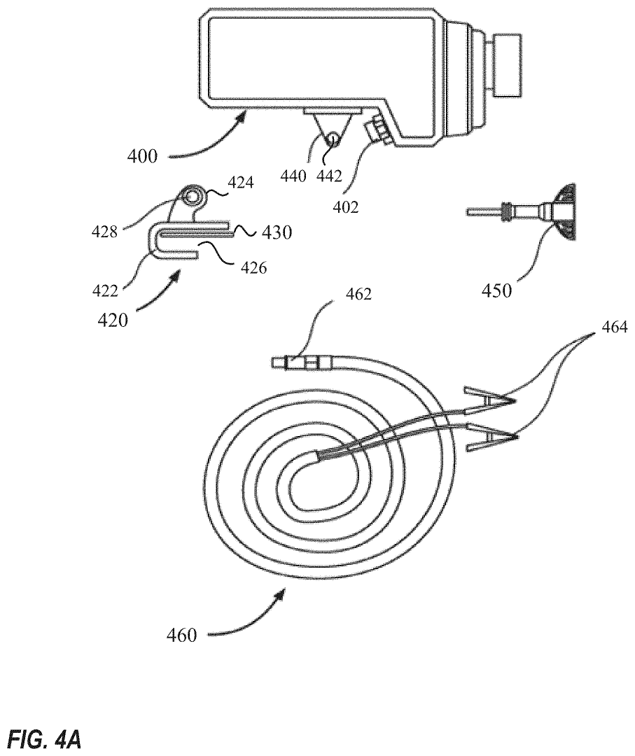

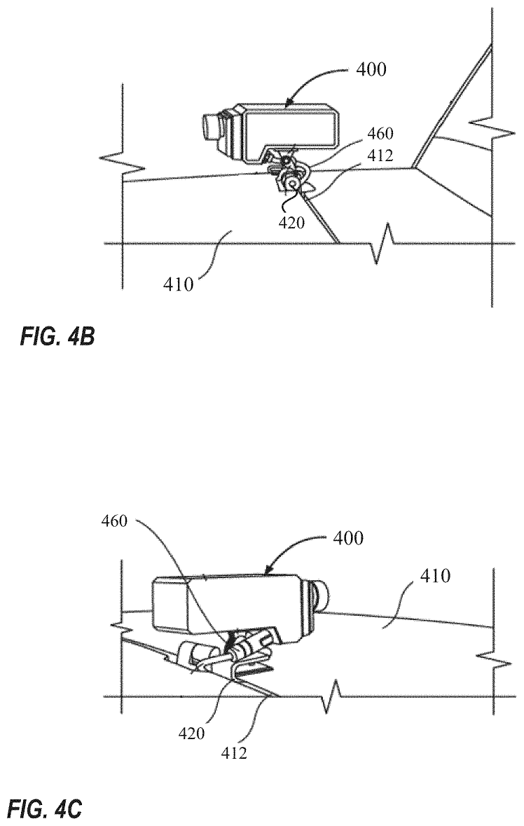

FIGS. 4A-C illustrate an example configuration for securing a night vision device 400 to a hood 410 of a vehicle. FIG. 4A illustrates the various components prior to installation. FIG. 4B illustrates a side view and FIG. 4C illustrates a rear view of the night vision device 400 secured to a hood 410. The mounting device 120 is a clip 420 that is secured to the hood 410 by placing it onto an end of the hood 410 extending from a lip 412 (opening between the hood 410 and other portions of vehicle adjacent to the hood 410). The clip 420 may include a shoe (U-shaped) 422 and a guide 424. An open end 426 of the shoe 422 may be placed on an end of the hood 410 and then the shoe 422 may be pushed onto the hood 410. A rubber mallet of hammer may be used to push the shoe 422 onto the hood 410. According to one embodiment, a mat 430 may be placed on top of the hood 410 before the shoe 422 is slid thereon to protect the hood 410 from any damage. The guide 424 extends upward from the hood 410 once the shoe 422 is secured thereon. The guide 424 may include a hole 428 formed therein for receiving a screw, bolt, clip, key or the like for securing the guide to the night vision device 400 (e.g., an aligned hole therein).

The night vision device 400 may include a guide 440 for engaging the guide 424. As illustrated, the guide 420 is extending from a lower edge of the night vision device 400. The guide 440 may include a hole 442 formed therein that is designed to align with the hole 428 in the guide 424 of the clip 420. According to one embodiment, one of the guides 440, 424 may include two aligned portions that surround the other one of the guides 424, 440. The configuration using two aligned portions would provide additional support. At least one of the aligned holes 428, 442 may be threaded to enable a screw, bolt of the like to be secured therein. According to one embodiment, the screw or bolt securing the guides 424, 440 together may be require a special key 450 to insert and remove in order to prevent an authorized person from removing.

The night vision device 400 mounted to the hood 410 may be powered by connecting it to the battery of the vehicle. A cable 460 may be utilized for connecting the night vision device 400 to the battery. The cable 460 may include a connector 462 for connecting to a port 402 on the night vision device 400. The cable 460 may include a pair of alligator clips 464 on the other end for connecting to the terminals of the battery. The cable 460 may run from the night vision device 400 and then pass through the lip 412 and run under the hood 410 to the battery. The cable 460 is not limited to the connector 462 or clips 464 illustrated. Rather various types of connectors may be utilized to connect to the night vision device 400 and the battery without departing from the current scope. Furthermore, the cable 460 is not limited to connecting to the battery of the vehicle to derive its power. Rather, it could be connected to other powered components in the vehicle (e.g., engine, fuse box) without departing the current scope. Furthermore, the cable could connect the night vision device with a power source separate from the vehicle.

It should be noted that the size, shape, orientation and configuration of the night vision device 400 illustrated in FIGS. 4A-C is for illustrative purposes only. The night vision device 400 is in no way intended to be limited to what is illustrated. Rather, the night vision device 400 could be any size, shape, orientation or configuration that enables hood mounting without departing from the current scope.

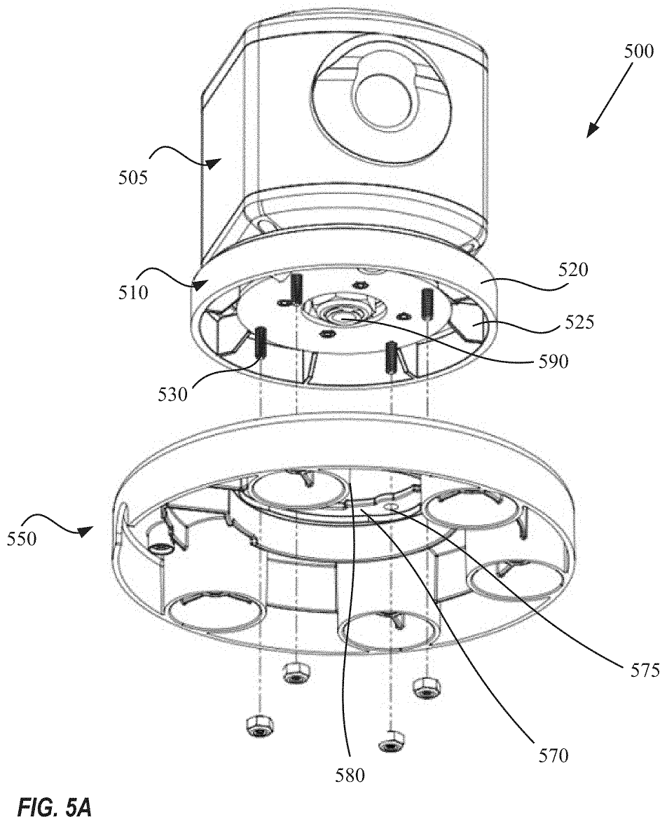

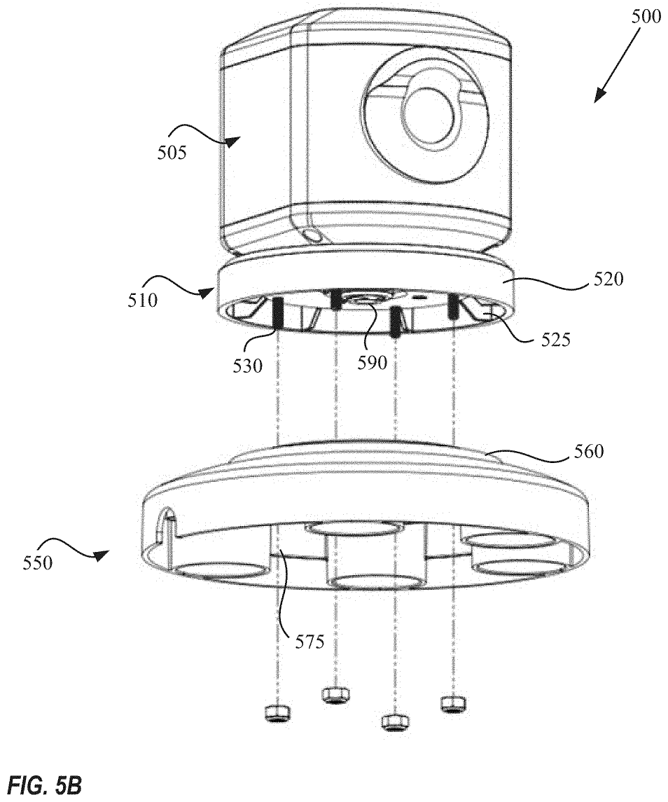

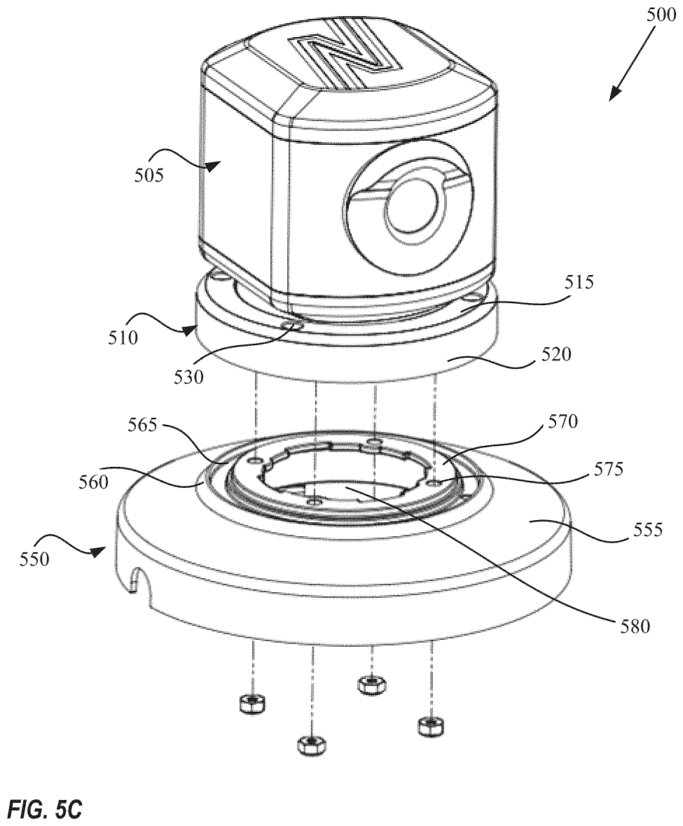

FIGS. 5A-C illustrate various views of an example night vision device 500 that includes a connection means 510 that enables it to be secured to various mounting devices 120 that are designed to be interface with the connection means 510. The connection means 510 may be integrated with, or connected to, a housing 505 of the night vision device 500. As illustrated, the connection means 510 is mounted to the housing 505 and secured thereto with, for example, a bolt 590. According to one embodiment, the housing 505 is capable of rotating around the connection means 510.

The connection means 510 may include a main surface 515, a rim 520 extending from the main surface 515, a plurality of tabs 525 extending inward from the rim 520, and a plurality of holes 530 in the main surface 515. A portion 550 of the mounting device 120 may include a main surface 555 having an external lip 560, a receiving channel 565, an internal lip 570 and holes 575 formed in the internal lip 570. The rim 520 may be located in the receiving channel 565 so the holes 530, 575 align and can be secured together with, for example, screws and nuts. The tabs 525 may ensure the rim 520 is secured within the receiving channel 565. The portion 550 may include an open interior 580 so as to not interfere with the connection between the connection means 510 and the housing 505 or the rotation of the housing 505 around the connection means 510 for implementations where the night vision device 500 may rotate.

The manner in which the portion 550 of the mounting device 120 is integrated with, or connected to, the mounting device 120 may vary based on the exact configuration of the mounting device 120 and what location of the vehicle the mounting device 120 is to be mounted to. The remaining portions of the mounting device 120 may be designed for specific implementations and are not illustrated.

It should be noted that the size, shape, orientation and configuration of the night vision device 500 (including housing 505) illustrated in FIGS. 5A-C is for illustrative purposes only. The night vision device 500 is in no way intended to be limited to what is illustrated. Rather, the night vision device 500 could be any size, shape, orientation or configuration that enables appropriate operation and use of the connection means 510 without departing from the current scope.

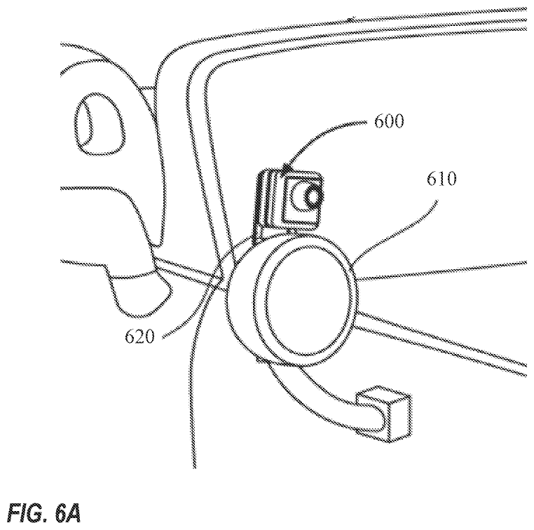

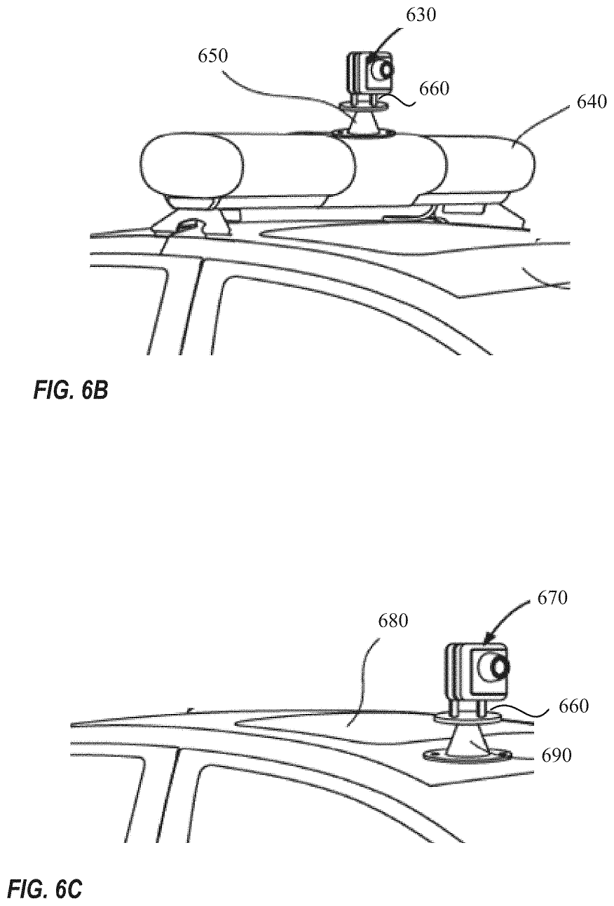

FIGS. 6A-6C illustrate the use of mounting devices to secure a night vision device to various different locations on the vehicle. A specific mounting device may be designed to mount to each of the various locations on the vehicle. Each of the different mounting devices may be designed to be secured to a connection means (such as 510 illustrated in FIGS. 5A-C) that is connected to the night vision device. In this manner, a standard night vision device having a connection means can connect to various different locations of a vehicle using different mounting devices.

FIG. 6A illustrates a night vision device 600 mounted/configured over a spotlight 610 extending from a side of the vehicle. A mounting device 620 is mounted to a top/rear of the spotlight 610 and then the night vision device 600 is connected to the mounting device 620 so as to extend above the spotlight 620. While not specifically illustrated for ease of illustration, the night vision device 600 may include a connection means (e.g., 500) to secure the night vision device 600 to the mounting device 620 as disclosed in FIGS. 5A-C above.

FIG. 6B illustrates a night vision device 630 mounted/configured over a light bar 640 of a vehicle. A mounting device 650 is secured to the light bar 640 and the night vision device 630 is connected to the mounting device 650 via a connection means 660. It should be noted that the connection means 660 and manner in which the night vision device 630 and the connection means 660 are configured is different than the manner illustrated in FIGS. 5A-C. FIG. 6C illustrates a night vision device 670 mounted/configured on a roof 680 of a vehicle. A mounting device 690 is secured to the roof 680 and the night vision device 670 is connected to the mounting device 690 via the connection means 660. As illustrated, the mounting devices 650, 690 are similar but are not limited thereto.

The locations in which a night vision device is mounted to the vehicle is not limited to those illustrated in FIGS. 6A-C. Rather, the night vision device could be mounted anywhere on a vehicle that would make sense and that a mounting device could be designed for. Locations that would make sense would include locations that can capture the pathway in which the vehicle would typically be traversing. For example, the night vision device could be mounted to a fender, grill or bumper of the vehicle.

The night vision devices (such as 600, 630, 670) that are mounted to various locations on the vehicle using different mounting devices (such as 620, 650, 690) may typically be permanently installed thereon and may be utilized along with other equipment such as light bars and spotlights. The vehicles that typically use this other equipment may include, but are not limited to, police, fire, rescue, and construction vehicles. These vehicles may have specific wiring configurations that are utilized with the equipment. According to one embodiment, the wiring of the night vision device to power and to a display device within the vehicle may follow protocols established for these vehicles.

It should be noted that the size, shape, orientation and configuration of the night vision devices 600, 630, 670 including the connection means 660 (when visible) illustrated in FIGS. 6A-C is for illustrative purposes only. The night vision device is in no way intended to be limited to what is illustrated. Rather, the night vision device could be any size, shape, orientation or configuration that enables appropriate operation and mounting without departing from the current scope.

According to one embodiment, the night vision device 110 may be designed for easy installation and removal from various locations on the vehicle without requiring any type of mounting devices 120. The night vision device 110 may include a magnet located within the housing that enables device to be magnetically secured to steel portions of the vehicle such as the hood and roof and possibly other portions of the frame. The magnet would need to be strong enough to be secured to the vehicle during operation.

According to one embodiment, the night vision device 110 may be capable of wireless powering thereof. That is, the night vision device 110 will not require a cable to connect it to a power source, such as the vehicles battery. The night vision device 110 may include an inductive receiver that receives power from an inductive transmitter that is located in close proximity thereto. The inductive transmitter may derive power from the vehicles power by being connected, for example, directly to the battery, the fuse box, the lighter, or a USB or other port located in the vehicle. Alternatively, the inductive transmitter may have its own power source (e.g., battery).

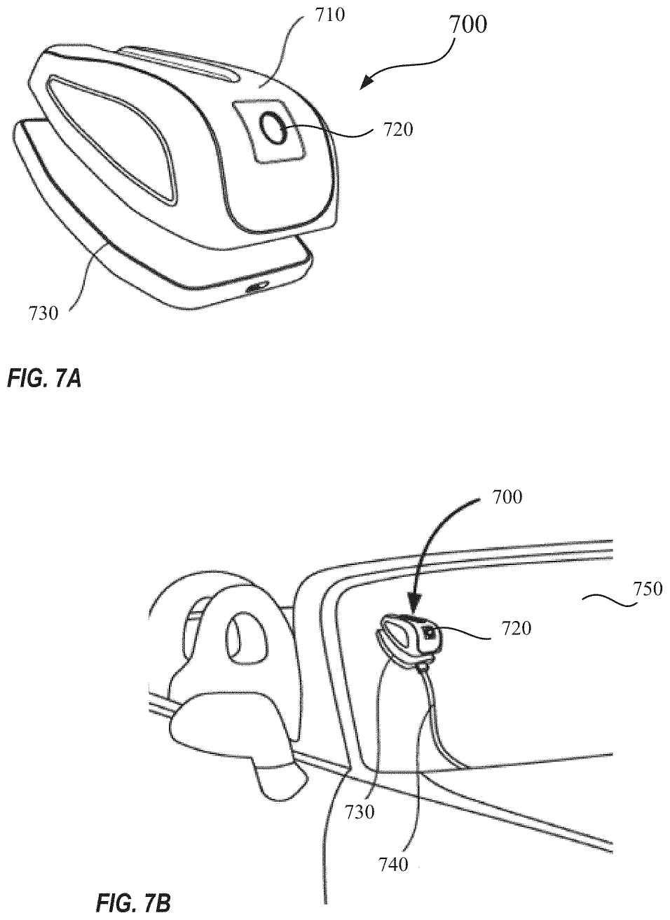

FIG. 7A illustrates an example night vision device 700 for wireless charging. The night vision device 700 includes a housing 710 securing all the components therein including the IR detector 720. Within the housing 710, or connected to the housing 710, is an inductive receiver (not illustrated). The inductive receiver is located so as to interact with an inductive transmitter 730. According to one embodiment, the inductive transmitter 730 may be located within the vehicle and the night vision device 700 may be mounted exterior to the vehicle in alignment with the inductive transmitter 730.

FIG. 7B illustrates the night vision device 700 being mounted to a windshield 750 of the vehicle. The inductive transmitter 730 is mounted on an interior of the windshield 750. The inductive transmitter 730 may be mounted to the windshield 750 in various manners including using tape, Velcro® or glue. The inductive transmitter 730 may utilize a cable 740 running inside the vehicle to connect to a power source (fuse box, lighter, USB connector). The night vision device 700 may be mounted external to the windshield 750 in alignment with the inductive transmitter 730. According to one embodiment, the inductive receiver may be mounted to the windshield 750 and the housing 710 may be mounted to the inductive receiver. In this fashion the night vision device 700 may be removed when not in use. The inductive receiver may be mounted to the windshield in a secure fashion. The inductive receiver may be mounted to the windshield using, for example, glue. The glue may be designed to hold in various external conditions and require specific chemicals to be removed. The housing 710 may be mounted to the inductive receiver in a secure fashion to prevent it from falling off, or coming lose, during use.

It should be noted that the IR detector 720 is configured within the housing 710 to point toward the front of the vehicle. According to one embodiment, the exact orientation of the IR detector 720 within the housing 710 may be adjusted as required to ensure that the IR detector 720 captures the desired objects. The orientation of the IR detector 720 may be manually adjusted or may be adjusted with either the display device 130 or a control device 140.

The display device 130 may be mounted internal to the vehicle so that a user (driver, passenger) can view the video stream of the objects that thermal radiation was received for. The display device 130 may be mounted in various locations much like a driver may mount their cell phone or a police officer may mount their laptop computer. A mounting mechanism may be used to hold the display device. The mounting mechanism may be secured to, for example, the windshield, the dashboard, air vents, or a center counsel between the seats. The mounting mechanism may be secured to the appropriate location in a temporary or permanent fashion. For example, the mounting mechanism may be secured using suction cups, clamps, or the like.

According to one embodiment, the user can place a non-slip mat on the dashboard of the vehicle and may place the display device 130 (such as a user's phone) thereon to ensure the display device 130 does not slide off the dashboard during driving. However, the placement of the display device 130 on the vehicle's dashboard in such a fashion may not be readily visible to the driver while they are driving the vehicle. Thus, a reflective display may be secured to a windshield so that the video stream displayed on the display device 130 can be mirrored or casted on the reflective display. According to an example, the reflective display is a reflective film having capability to adhere onto the windshield of the vehicle.

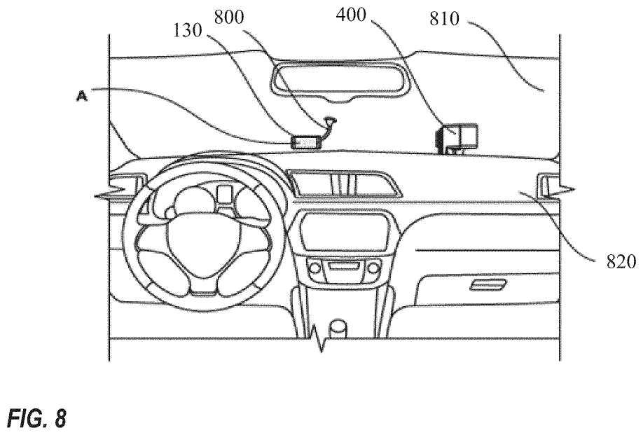

FIG. 8 illustrates a display device 130 utilized with the thermal radiation night vision system mounted within the vehicle. As illustrated, the night vision device 400 is mounted to the hood of the vehicle. The night vision device 400 is in no way intended to be limited thereby. As illustrated, the display device 130 is a smart phone that is mounted to the windshield 810 with a mounting mechanism 800. The display device 130 is not limited to a smart phone being mounted to the windshield 810. The display device 130 could be mounted various other locations including on the dashboard 820. The display device 130 displays objects detected by the night vision device 400, such as object A.

Using the thermal radiation night vision system while driving provides a user (driver, passenger) with thermal images of objects located in the path they are traversing that may not be visible to the human eye. Accordingly, the driver can visualize what is presented on the display device 130 and make appropriate decisions to avoid any possible accidents during night or low light conditions.

Although particular embodiments of the invention have been described in detail for purposes of illustration, various modifications and enhancements may be made without departing from the spirit and scope of the invention.

The invention claimed is:

1. A night vision system for a vehicle, the system comprising:
a thermal radiation night vision device mounted external to the vehicle, wherein the thermal radiation night vision device is to detect thermal radiation from one or more objects located in close proximity to the vehicle, and wherein the thermal radiation night vision device creates a video stream from the detected thermal radiation from the one or more objects and transmits the video stream to a display device located within an interior of the vehicle for viewing by a driver of the vehicle;
a mounting system to secure the thermal radiation night vision device to the vehicle; and
a means for providing power to the thermal radiation night vision device.

2. The night vision system of claim 1, wherein the thermal radiation night vision device comprises:
a far wave infrared thermal detector for detecting thermal radiation from the one or more objects;
a processor to receive the detected thermal radiation, process the detected thermal radiation, and generate the video stream corresponding to the detected thermal radiation; and
a communication interface to transmit the generated video stream to the display device.

3. The night vision system of claim 2, wherein the far wave infrared thermal detector is a microbolometer.

4. The night vision system of claim 2, wherein the thermal radiation night vision device further comprises a memory configured to store the generated video stream for later retrieval.

5. The night vision system of claim 1, wherein the mounting system includes a connector having a standard interface that is to connect to a mounting device that is mounted to the vehicle.

6. The night vision system of claim 5, wherein the mounting device is secured to a roof of the vehicle.

7. The night vision system of claim 5, wherein the mounting device is secured to a light bar mounted on the vehicle.

8. The night vision system of claim 5, wherein the mounting device is secured to a fender of the vehicle.

9. The night vision system of claim 5, wherein the mounting device is secured to a grill of the vehicle.

10. The night vision system of claim 5, wherein the mounting device is secured to a bumper of the vehicle.

11. The night vision system of claim 1, wherein the mounting system is configured to replace portions of a frame of a device mounted to the vehicle in order to secure the thermal radiation night vision device to the mounted device.

12. The night vision system of claim 11, wherein the mounted device is a spotlight.

13. The night vision system of claim 1, wherein the means for providing power to the thermal radiation night vision device is a cable providing connectivity between the thermal radiation night vision device and a power source for the vehicle.

14. The night vision system of claim 1, wherein the means for providing power to the thermal radiation night vision device includes an inductive charging transmitter located within the vehicle and connected to a power source in the vehicle and an inductive charging receiver located exterior to the vehicle, wherein the inductive charging transmitter and the inductive charging receiver are in close proximity to each other and the inductive charging transmitter wireless transmits power to the inductive charging receiver.

15. The night vision device of claim 14, wherein the inductive charging transmitter is mounted on an interior surface of a window and the inductive charging receiver is mounted on an exterior of the window in alignment with the inductive charging transmitter, and wherein the mounting system includes a housing of the thermal radiation night vision device that is configured to be mounted onto the inductive charging receiver.

16. The night vision system of claim 1, wherein the display device is selected from a smart phone, a laptop computer or a tablet computer.

17. The night vision system of claim 1, wherein the display device is detachably mounted to a windshield or a dashboard of the vehicle.

18. A night vision system for a vehicle, comprising:
a far wave infrared thermal detector located external to the vehicle to detect thermal radiation from one or more objects;
a processor to receive the detected thermal radiation, process the detected thermal radiation, and generate a video stream corresponding to the detected thermal radiation;
a communication interface to transmit the generated video stream to a display device located internal to the vehicle for viewing within the vehicle;
a memory configured to store the generated video stream for later retrieval;
a mounting system to secure the night vision system to the vehicle; and
a means for providing power to the night vision system.

19. The night vision system of claim 18, wherein the mounting system includes a connector having a standard interface that is to connect to a mounting device that is mounted to the vehicle, wherein the mounting device is secured to a roof, a light bar, a fender, a grill or a bumper of the vehicle.

20. The night vision system of claim 18, wherein the mounting system is configured to replace a portion of a frame of a spotlight mounted to the vehicle in order to secure the thermal radiation night vision device to the spotlight.
